(19) United States
(12) Patent Application Publication
(10) Pub. No.: US 2008/0110807 A1
(43) Pub. Date: May 15, 2008

(54) Screen for Particle Separation

(75) Inventor: Jacques Goguen, Cocagne (CA)

Correspondence Address: Kelleher IP PLLC;SEAN LIAM KELLEHER, 16 PECKSLIP RD, CARMEL, NY, 10512, US

(73) Assignee: Allain Equipment Manufacturing Ltd., Notre-Dame (CA)

(21) Appl. No.: 11/937,509

(22) Filed: Nov. 9, 2007

Related U.S. Application Data
(60) Provisional application No. 60/865,354, filed on Nov. 10, 2006.

(51) Int. Cl. B07B 1/12

(52) U.S. Cl. 209/394; 209/308; 209/395

(57) ABSTRACT

A screening apparatus for separating particles is disclosed which consists of a plurality of rows of elongated members disposed in a staggered spacial relationship. The screening apparatus of the present invention is especially useful in preventing the spiking of particles during the screening process.

### FIELD OF THE INVENTION

The present invention relates to a screening apparatus for particle separation.

### BACKGROUND OF THE INVENTION

Environmentalists have raised a consciousness concerning the contamination of our environment with unsightly and virtually uncontrollable depositing of waste and debris usually at designated landfill sites. This debris may come from many sources including demolition sites, razing or gutting of existing buildings, land clearing areas, manufacturing and construction sites to mention a few.

One of the major problems and disadvantages that exist with respect to current landfill, sites include fires, many of which are fanned by underground tunnels of air caused by the bulkiness and large size of the debris. Fires of this type are generally very difficult to contain and to extinguish.

Another serious problem with respect to landfill sites is the slowness and the uncontrollable nature of the degradation of the debris also caused by the bulkiness and large size of many of the items deposited at these sites.

There have been attempts to solve the handling of waste and the landfill problems, but most have been ineffectual. For example, at many building construction and demolition sites, compactors often times receive the building debris. While compaction of this material does to some extent reduce its bulkiness, it does not reduce the size or bulkiness of the individual items. At best, compaction merely reduces the amount of air space. Compaction of debris is not an effective solution to landfill problems.

Certain machinery has been proposed for reducing the size of debris, but these machines have their limitations, particularly in terms of efficiency, power requirements, lack of speed, and in many instances, the inability to handle relatively large pieces of debris. Some of the known existing machinery includes “SLASHBUSTERS” offered by D & M Machine Division Inc., Montesano, Wash., “STUMPMASTER” marketed by Stumpmaster, Inc., Rising Fawn, Ga. and the M80 Grapple Loading Portable Universal Refiner marketed by Universal Refiner Corporation, Montesano, Wash. Augers have also been proposed but usually require too much power and cannot reduce relatively large size waste materials. Machines of the foregoing type only have limited application at best and are unable to completely resolve the landfill problems which require the ability to handle all types and sizes of debris and reduce it to a size manageable for landfill areas that would enhance the biodegradation process.

For shredding large objects such as railroad ties and demolition waste, it has been known to use heavy duty shredders which include a rotating auger within a shredding chamber. The material to be shredded is typically fed into one end of such a device and moved down the length of the shredding chamber by the auger towards a discharge end.

U.S. Pat. No. 5,108,040 discloses an auger shredder having a tapered auger which causes material to be shredded by the meshing of teeth on the auger periphery with breaker bars affixed to the shredding chamber. The auger is pinned at the input end of the shredder, where a drive motor for the auger is located, while the opposite end of the auger extends into an extrusion tube.

U.S. Pat. No. 4,976,471 discloses a mill for the comminution of plastic or wood into smaller pieces. The mill has a feeder screw which is driven by a motor with a discharge funnel adjacent the drive end.

U.S. Pat. Nos. 4,767,065, 5,011,088, and 4,632,317 also show auger-type material disintegrating devices having alternative designs.

U.S. Pat. No. 4,133,489 shows a shredding device having grate segments which are pivotably mounted at one end and moved at the other end by means of hydraulic jacks. U.S. Pat. No. 681,984 shows a pulverizer in which the lower screen is adjustable upward to accommodate for wear of the beater. U.S. Pat. Nos. 2,149,571, 3,829,030, and 4,009,836 show other pulverizers or hammer mills provided with adjustable grates or screens.

U.S. Pat. Nos. 4,042,183, 5,269,355, 5,148,999, and 4,978,078 show various configurations of various projections or teeth on augers for comminuting material.

Although certain of the prior designs such as that shown in U.S. Pat. No. 5,108,040 have proven to be adequate for shredding bulk material such as railroad ties, utility poles and the like, they suffer from certain inefficiencies and cannot deal with very large materials to be sorted.

It is also known in the industry that large items can be sorted through the use of a finger screener comprised of a single row of fingers. One of the common problems encountered with this type of screening is that some particles of material end up going through the finger screen in a vertical fashion. This phenomenon is commonly referred to as spiking which in turn increases the fluctuation of fine and medium particle sizes. People in the industry live with this problem and some depend on a secondary screening to remove the larger particles that have gone through in a vertical fashion.

Based on the above, there is a need for a screening apparatus for large items that minimizes and/or eliminates the passage of large items in a vertical fashion through a screening apparatus.

### SUMMARY OF THE INVENTION

It is an object of the present invention to provide a screening apparatus for separating particles comprising a frame, connecting means and a plurality of elongated members positioned in a staggered spacial relationship wherein the connecting means secure the elongated members in the frame.

### BRIEF DESCRIPTION OF THE DRAWINGS

It will now be convenient to describe the invention with particular reference to one embodiment of the present invention. It will be appreciated that the drawings relate to one embodiment of the present invention only and are not to be taken as limiting the invention.

FIG. 1 is a cross-section view of a conventional screen design in the industry;

FIG. 2 is a cross-section view of one embodiment of the present invention; and

FIG. 3 is a perspective view of one embodiment of the present invention.

### DETAILED DESCRIPTION OF THE DRAWINGS

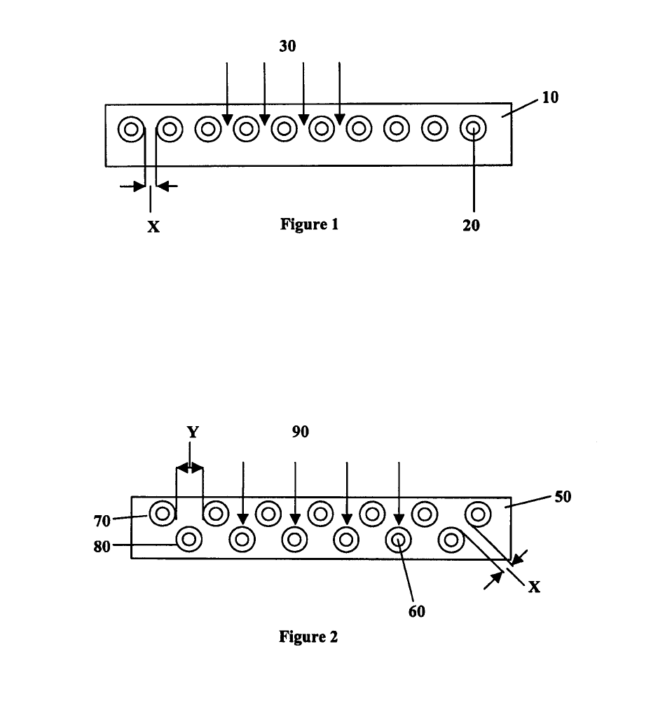

With reference to FIG. 1, in conventional screening apparatus a frame 10 has elongated members 20 attached to the frame 10. Materials (not shown) are passed through the screening apparatus in the direction 30 in order to allow for the materials to be sorted. The elongated members 20 are distanced from one another at the desired distance X based on the required sorting application. The drawback of this conventional application is that when particles of material that have a considerable length but a width that is equal or less than X, the particle can pass through the elongated members 20 but is actually too large given its length.

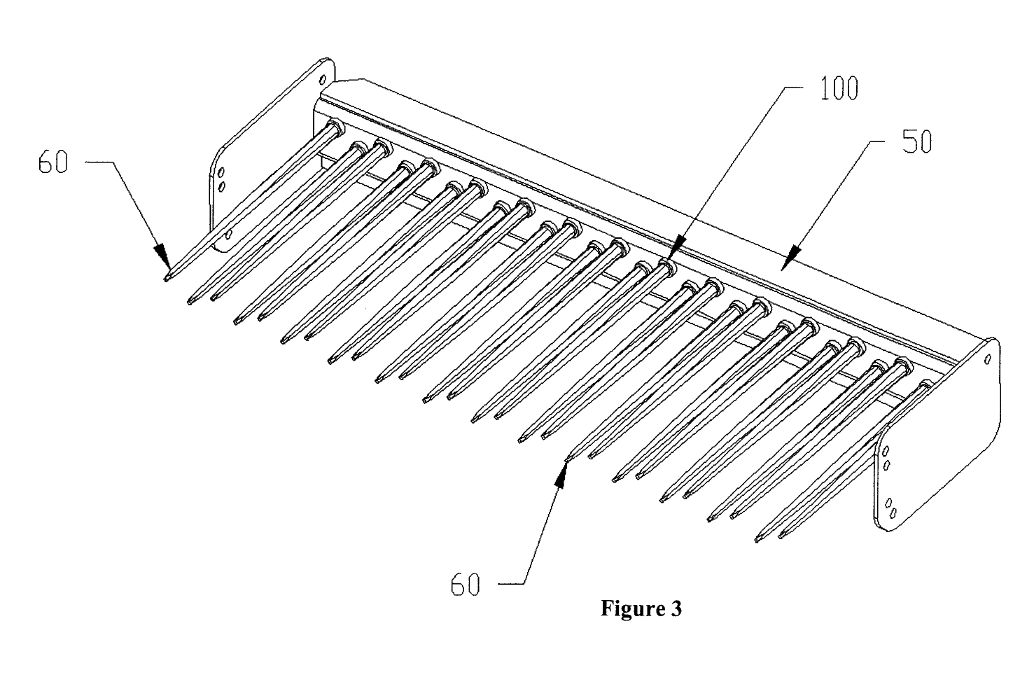

With reference to FIG. 2, in one embodiment of the present invention, the screening apparatus has a frame 50 with elongated members 60 positioned in spacial relationship to one another allowing for a first and second row 70 and 80 of elongated members 60 to be present. The second row 80 is positioned in a staggered fashion from the first row 70 of elongated members 60. Materials (not shown) are passed through the screening apparatus in the direction 90 in order to allow for the materials to be sorted. The positioning of rows 70 and 80 assures that if a particle of considerable length passes through the first row 70 of elongated members 60, it will impact at least one of the elongated members 60 in the second row 80.

With further reference to FIG. 2, the distance X as found and defined in FIG. 1 is actually present between two elongated members with one elongated members 60 from the first row 70 and a second elongated member 60 from the second row 80. The distance Y as identified in FIG. 2 is greater than distance X depending on the desired application, however distance Y is sufficient to assure that a distance X is always present between the elongated members from each rows 70 and 80 as shown.

With reference to FIG. 3, one embodiment of the present invention is shown. Frame 50 is located at one end of the elongated members 60 and connecting means 100 such as for example nuts are used to secure the elongated members 60 to frame 50. A worker skilled in the relevant art would be familiar with a multitude of connecting means which could be used to secure the elongated members 60 to frame 50 without modifying the efficacy of the screening apparatus of the present invention.

The frame 50 may be fabricated from a number of materials as would be known to a worker skilled in the relevant art. For example such materials could be steel, aluminum, stainless steel, alloys and plastics. The overall shape of the frame can also be modified to any specific application and also to any size limitation of the screening apparatus of the present invention.

The elongated members 60 may be fabricated from a number of materials as would be known to a worker skilled in the relevant art. For example such materials could be steel, aluminum, stainless steel, alloys and plastics. The overall shape and size of the elongated members can also be modified to any specific application of the present invention.

The elongated members of the present invention can be positioned within the frame through the use of numerous connecting means as would be known by a worker skilled in the relevant art. For example, the elongated members can be secured to the frame through the use of bolts, nuts, cables, clamps, welds, a male/female couplers, dowels, keys, pins, rivets and screws. The use of such connecting means allow for replacement of any broken or defective elongated member after use of the screening apparatus has commenced.

It is to be understood that the above detailed description of one embodiment of the present invention is provided as an example only. Various details of the design may be modified without departing from the true spirit and scope of the invention.

The embodiment of the invention in which an exclusive property or privilege is claimed is defined as follows:

1. A screening apparatus for separating particles comprising:
i) a frame;
ii) connecting means; and
iii) a plurality of elongated members positioned in a staggered spacial relationship
wherein the connecting means secure the elongated members to the frame.

2. The screening apparatus of claim 1 wherein the connecting means are nuts.

3. The screening apparatus of claim 1, wherein the connecting means are male/female couplers.

4. The screening apparatus of claim 1 wherein the connecting means are dowels.

5. The screening apparatus of claim 1 wherein the connecting means are lockable pins.

6. The screening apparatus of claim 1 wherein the connecting means are screws.

7. The screening apparatus of claim 1 wherein the elongated members are made from steel.

8. The screening apparatus of claim 1 wherein the elongated members of claim 1 are made of aluminum.

9. The screening apparatus of claim 1, wherein the elongated members of claim 1 are made from an alloy.

10. The screening apparatus of claim 1 wherein the elongated members of claim 1 are made from stainless steel.
